(19) United States
(12) Patent Application Publication
(10) Pub. No.: US 2015/0177991 A1
(43) Pub. Date: Jun. 25, 2015

(54) Hybrid Content-Distribution System and Method

(71) Applicant: ChengDu HaiCun IP Technology LLC, ChengDu (CN)

(72) Inventor: Guobiao ZHANG, Corvallis, OR (US)

(73) Assignee: CHENGDU HAICUN IP TECHNOLOGY LLC, ChengDu (CN)

(21) Appl. No.: 14/637,395

(22) Filed: Mar. 4, 2015

Related U.S. Application Data
(63) Continuation of application No. 13/597,228, filed on Aug. 28, 2012.
(60) Provisional application No. 61/529,925, filed on Sep. 1, 2011.

(51) Int. Cl. G06F 3/06

(52) U.S. Cl. CPC G06F 3/0608; G06F 3/0679; G06F 3/0655; G06F 2206/1014

(57) ABSTRACT

A hybrid content-distribution system uses re-writable memory (RWM) and mask-ROM to distribute contents. During a publication period, new contents are incrementally transferred to the RWM. At the end of the publication period, a user receives a mask-ROM storing the same contents, which are then deleted from the RWM. A mask-ROM cartridge comprises a plurality of electrically-coupled slots for holding incrementally released mask-ROMs.

### CROSS-REFERENCE TO RELATED APPLICATIONS

This is a continuation of an application “Hybrid Content-Distribution System and Method”, Ser. No. 13/597,228, filed Aug. 28, 2012, which claims benefits of a provisional application “Content-Delivery System and Method Using Three-Dimensional Printed Memory”, Application Ser. No. 61/529,925, filed Sep. 1, 2011.

### BACKGROUND

1. Technical Field of the Invention

The present invention relates to the field of integrated circuit, more particularly to mask-programmed read-only memory (mask-ROM).

2. Prior Arts

Re-writable memory (RWM, e.g., a flash memory) is commonly used for content storage. Because a RWM is relatively expensive, a user can only purchase a limited amount of the RWM. As a result, the user has to keep deleting contents from the RWM when it becomes full. In other words, the past contents have to be deleted when the new contents are available. This “delete-add” mode limits the user's access to only the new contents. On the other hand, mask-ROM offers another option for content distribution. When a new mask-ROM is issued, the user only needs to add it to his/her collection without having to discarding the old mask-ROM. This “add-only” mode broadens the user's access to both past and new contents.

Because the prior-art mask-ROM has a limited storage capacity, when it is used for content distribution, a separate new mask-ROM card is issued for each newly released content. FIG. 1 illustrates an example. Contents C₁ (e.g. movie 1), C₂ (e.g. movie 2), . . . are released at time t₁, t₂, . . . , respectively. A separate mask-ROM card is issued for each new content: at time t₁, a first mask-ROM card m₁, which stores the content C₁, is delivered to a user; at time t₂, a second mask-ROM card m₂, which stores the content C₂, is delivered to the user; . . . . As more and more contents are released, this content-distribution method becomes cumbersome, because the user needs to manage hundreds, even thousands of mask-ROM cards.

With the advent of three-dimensional mask-programmed read-only memory (3D-MPROM), the storage capacity of the mask-ROM greatly improves. U.S. Pat. No. 5,835,396 discloses a 3D-MPROM. It is a monolithic semiconductor memory. As illustrated in FIG. 2, a typical 3D-MPROM comprises a semiconductor substrate 0 and a 3-D stack 10 stacked above. The 3-D stack 10 comprises M (M≧2) vertically stacked memory levels (e.g. 10A, 10B). Each memory level (e.g. 10A) comprises a plurality of upper address lines (e.g. 2a), lower address lines (e.g. 1a) and memory cells (e.g. 5aa). Each memory cell stores n (n≧1) bits. Memory levels (e.g. 10A, 10B) are coupled to the substrate 0 through contact vias (e.g. 1av, 1av′). The substrate circuit 0X in the substrate 0 comprises a peripheral circuit for the 3-D stack 10. With a storage capacity up to TB, 3D-MPROM can be used for mass publication, i.e. mass distribution of mass contents.

### Objects and Advantages

It is a principle object of the present invention to provide a content-distribution method that offers a user timely access to the new contents while keeping the overall storage cost low.

It is a further object of the present invention to provide a content-distribution system that makes memory-card management easier for a user.

In accordance with these and other objects of the present invention, hybrid content-distribution system and method are disclosed.

### SUMMARY OF THE INVENTION

The present invention discloses a hybrid content-distribution system. It comprises a playback device (e.g. cellular phone, internet TV, or computer) which uses both re-writable memory (RWM) and mask-ROM (e.g., a 3D-MPROM) to store contents. The RWM is part of the playback device, while the mask-ROMs are periodically delivered to a user. Because it is much less expensive than the RWM, mask-ROM can be used to store past contents. Being re-writable, RWM can be used to store new contents. During a publication period, new contents are incrementally transferred to the playback device and saved into the RWM. At the end of the publication period, a user receives a mask-ROM card which stores a collection of the transferred contents. To make room for the contents to be released during the next publication period, the contents common to the mask-ROM and the RWM are deleted from the RWM. Hybrid content-distribution offers the user timely access to the new contents while keeping the overall storage cost low.

The present invention further discloses a mask-ROM holding device (e.g., a cartridge). It comprises a plurality of electrically coupled slots which are empty at first. A first mask-ROM is inserted into a first slot during a first period; a second mask-ROM is inserted into a second slot during a second period . . . . More mask-ROMs can be inserted into the remaining slots until the whole cartridge becomes full.

### BRIEF DESCRIPTION OF THE DRAWINGS

FIG. 1 discloses a content-distribution method from prior arts;

FIG. 2 is a cross-sectional view of a 3D-MPROM (prior art);

FIG. 3 is a block diagram of a preferred hybrid content-distribution system and its communication with a remote server;

FIGS. 4A-4B illustrate two preferred playback devices;

FIG. 5 is a flow chart for a preferred hybrid content-distribution method;

FIG. 6 illustrates the amount of the occupied space in the RWM at different time points;

FIGS. 7A-7B are cross-sectional views of a preferred 3D-MPROM cartridge at different time points T₁, T₂.

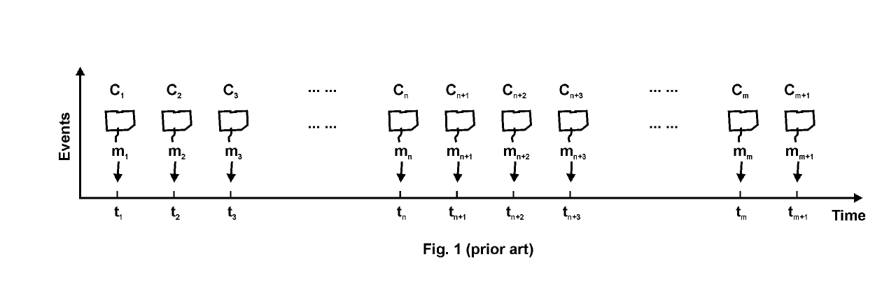

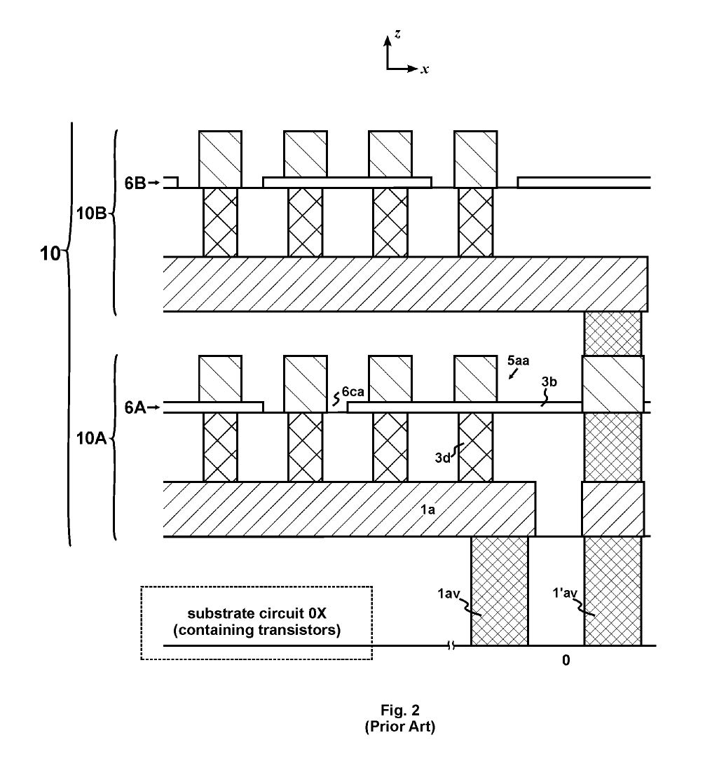

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention uses 3D-MPROM as an example to explain the concept of hybrid content-distribution. The preferred embodiments disclosed herein can be extended to any large-capacity mask-ROM. A large-capacity mask-ROM has a storage capacity on the order of GB, even on the order of TB. In the present invention, the primary data-recording means for a mask-ROM includes photo-lithography and imprint-lithography. The “mask” in the mask-ROM includes data-mask used in photo-lithography, as well as nano-imprint mold or nano-imprint template used in imprint-lithography. The mask-ROM made with nano-imprint method is also referred to as imprinted memory.

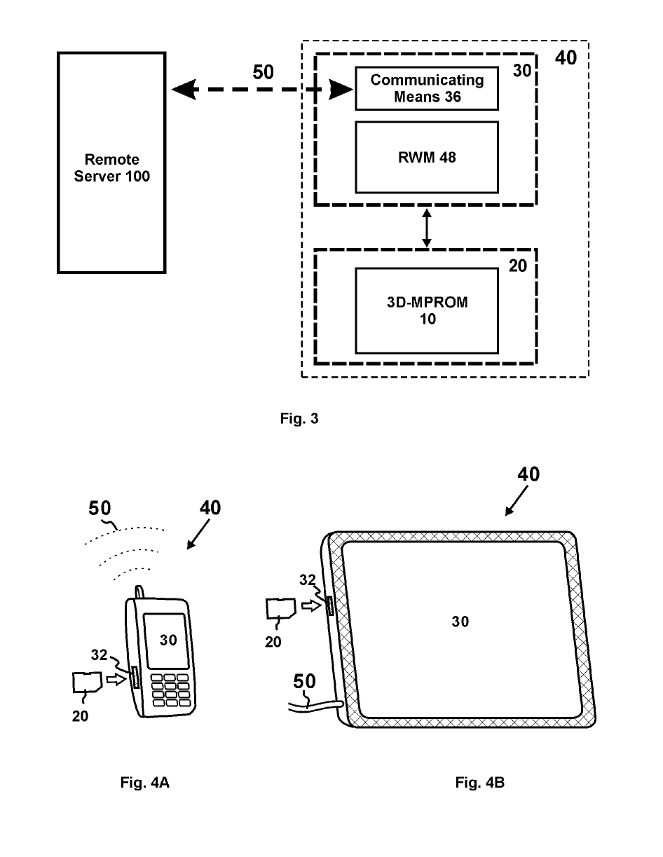

Referring now to FIG. 3, a preferred hybrid content-distribution system 40 and its communication channel 50 with a remote server 100 are disclosed. It comprises a memory card 20 and a playback device 30. The memory card 20 could comprise a memory package or a memory module. It contains at least one 3D-MPROM die, more generally, at least one large-capacity mask-ROM die. The memory card 20 stores contents such as movies, video games, maps, music library, book library, and/or softwares.

The playback device 30, more generally, a consumer processing apparatus, can read and process data from the memory card 20, e.g. playing a movie or video game, reading a map, listening to music, reading books, or running software. The playback device 30 comprises a communicating means 36 and a re-writable memory (RWM) 48. The communicating means 36 communicates with a remote server 100 through a communication channel 50. The remote server 100 stores a mass-content library. The communication channel 50 includes internet, wireless LAN (WiFi) and cellular (e.g. 3G, 4G, 5G) signals. The RWM 48 is a non-volatile re-writable memory, e.g. a flash memory.

FIG. 4A illustrates a preferred playback device 30—a cellular phone. It communicates with the remote server 100 via cellular signals 50. The cellular phone 30 further comprises a slot 32 for holding the memory card 20, which can be inserted into or removed from the cellular phone 30. FIG. 4B illustrates another preferred playback device 30—an internet TV (or, a computer). It communicates with the remote server 100 via internet signals (including wired and wireless internet signals) 50. The internet TV (or, computer) 30 further comprises a slot 32 for holding the memory card 20, which can be inserted into or removed from the internet TV (or, computer) 30.

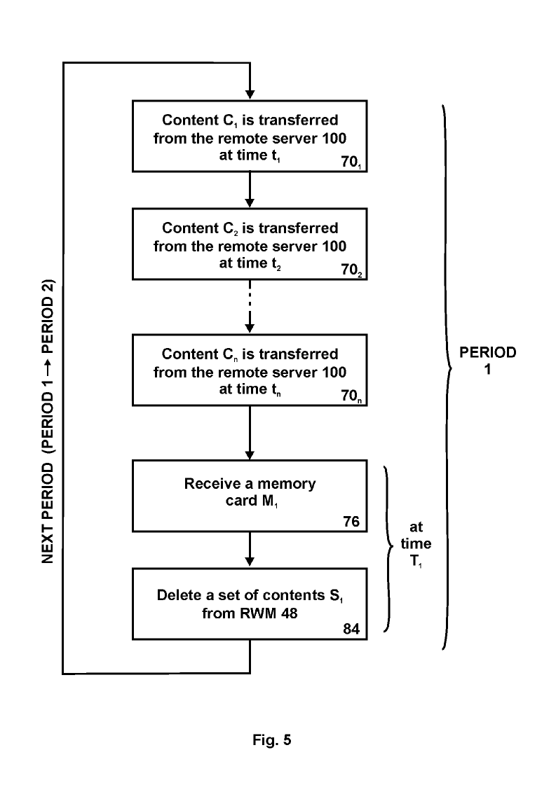

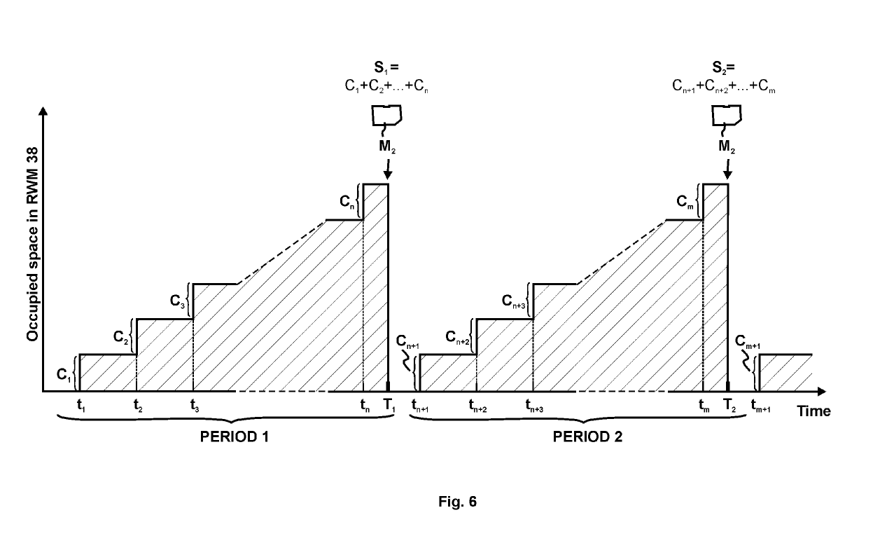

The present invention discloses a hybrid content-distribution method. It takes advantage of the fact that the 3D-MPROM is much less expensive than the RWM and stores the past contents in the 3D-MPROM. It also takes advantage of the fact that the RWM is re-writable and stores the new contents in the RWM. FIG. 5 discloses a preferred hybrid content-distribution method; and FIG. 6 illustrates the amount of the occupied space in the RWM 48 at different time points.

The preferred hybrid content-distribution method includes a number of publication periods (e.g. PERIOD 1 and PERIOD 2). Each publication period comprises similar steps. During PERIOD 1 (e.g. during the first two months), new contents (i.e. the contents released during the current publication period), once released, are transferred from the remote server 100 to the playback device 30. For example, content C₁ (e.g. movie 1) is transferred at time t₁ (step 70₁); content C₂ (e.g. movie 2) is transferred at time t₂ (step 70₂); . . . ; content Cₙ (e.g. movie n) is transferred at time tₙ (step 70ₙ). Here, new contents are either downloaded by the playback device 30 or pushed in by the remote server 100. The transferred contents are stored in the RWM 48. This is reflected by the staircase RWM curve between t₁ and T₁ of FIG. 6. During PERIOD 1, the contents C₁, C₂, . . . Cₙ are accessed from the RWM 48.

At the end of PERIOD 1, a first set of contents S₁ (=C₁+C₂+ . . . +Cₙ) is accumulated in the RWM 48. At time T₁, a user receives a first memory card M₁ (step 76), which permanently stores the first set of contents S₁. Afterwards, the first set of contents S₁ is deleted from the RWM 48 (step 84). This is reflected by the steep drop of the RWM curve at T₁ in FIG. 6. Because the RWM 48 is emptied, PERIOD 2 can now start. After PERIOD 1, the contents C₁, C₂, . . . Cₙ can be accessed from the memory card M₁.

During PERIOD 2 (e.g. during the next two months), similar steps (steps 70₁-84) are performed. Contents Cₙ₊₁, Cₙ₊₂, . . . Cₘ are transferred at time tₙ₊₁, tₙ₊₂, . . . tₘ, respectively. During this period, the contents Cₙ₊₁, Cₙ₊₂, . . . Cₘ are accessed from the RWM 48. At the end of PERIOD 2, a second set of contents S₂ (=Cₙ₊₁+Cₙ₊₂+ . . . +Cₘ) is accumulated in the RWM 48. At time T₂, the user receives a second memory card M₂, which permanently stores the second set of contents S₂. Then the second set of contents S₂ is deleted from the RWM 48. After PERIOD 2, the contents Cₙ₊₁, Cₙ₊₂, . . . Cₘ are accessed from the second memory card M₂.

Because the playback device 30 can communicate with the remote server 100 in a timely manner, the preferred hybrid content-distribution method offers the user timely access to the new contents. Moreover, because the past contents (i.e. contents released during the previous publication periods) are stored in the memory cards (e.g. M₁, M₂, . . . ) and only the new contents need to be stored in the RWM 48, the playback device 30 only needs a limited amount of the RWM 48. Since the 3D-MPROM is much less expensive than the RWM, the overall storage cost for this hybrid content-distribution method is much lower than prior arts where all contents are stored in the RWM.

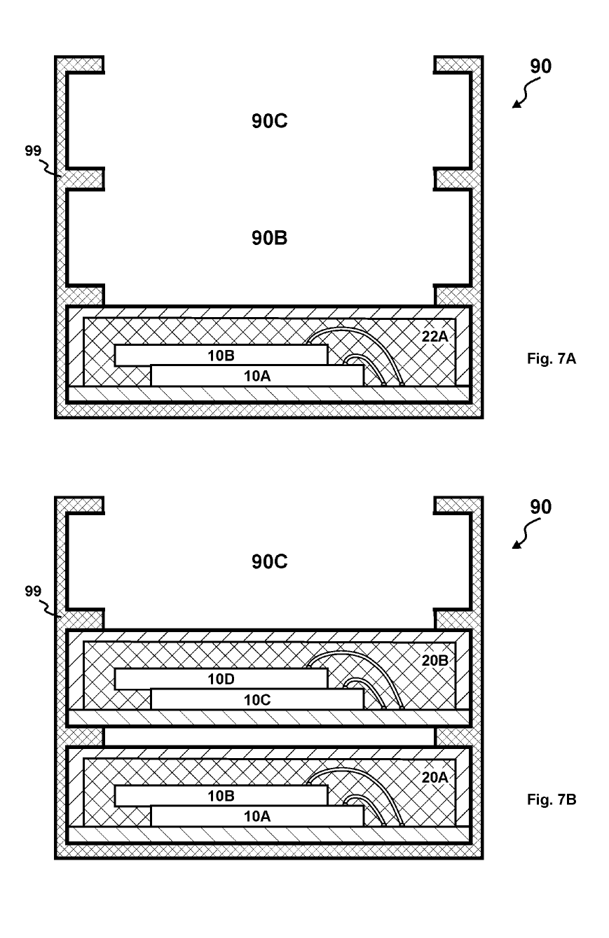

The present invention further discloses a preferred 3D-MPROM cartridge 90 that can accommodate hybrid content-distribution. FIGS. 7A-7B illustrate its configurations at different time points T₁, T₂. The 3D-MPROM cartridge 90 comprises a cartridge frame 99, which comprises a plurality of electrically coupled slots (e.g. 90A, 90B, 90C). These slots are empty at first. At T₁, a memory card 20A, which comprises two vertically stacked 3D-MPROM dice 10A, 10B, is released. It is inserted into the bottom slot of the memory cartridge 90. At this time, the slots 90B, 90C are empty. At T₂, another memory card 20B, which comprises two vertically stacked 3D-MPROM dice 10C, 10D, is released. It is then inserted into the slot 90B. At this time, the slot 90C is empty. At T₃, a third memory card can be inserted into the slot 90C (not shown). The cartridge frame 99 can provide electrical connections between the memory cards 20A and 20B (not shown). Preferably, the playback device 30 can directly read data from the 3D-MPROM cartridge 90. Apparently, the preferred memory cartridge 90 can have more than three slots. For example, it may comprise twelve slots. Assuming a new memory card is released every month, a single memory cartridge can hold all memory cards released in a year. The memory cartridge 90 makes the memory-card management much easier.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A hybrid content-distribution system including a mask-ROM holding device and a processing apparatus, wherein:
said mask-ROM holding device comprising at least first and second electrically coupled slots;
said processing apparatus comprising:
a communicating means for incrementally transferring a plurality of contents;
a re-writable memory (RWM) for storing said plurality of contents;
means for coupling to said mask-ROM holding device;
wherein:
said first and second slots are empty before a first period;
first contents are transferred by said communication means and stored in said RWM during said first period;
a first mask-ROM storing said first contents is inserted into said first slot and said first contents are deleted from said RWM at the end of said first period;
second contents are transferred by said communication means and stored in said RWM during a second period following said first period;
a second mask-ROM storing said second contents is inserted into said second slot and said second contents are deleted from said RWM at the end of said second period.

2. The hybrid content-distribution system according to claim 1, wherein said processing apparatus is a cellular phone, an internet TV, or a computer.

3. The hybrid content-distribution system according to claim 1, wherein said communicating means include internet, wireless LAN and cellular communication means.

4. The hybrid content-distribution system according to claim 1, wherein said RWM is a flash memory.

5. The hybrid content-distribution system according to claim 1, wherein said first or second mask-ROM is located in a memory card.

6. The hybrid content-distribution system according to claim 5, wherein said mask-ROM is a three-dimensional mask-ROM (3D-MPROM).

7. The hybrid content-distribution system according to claim 5, wherein said mask-ROM is an imprinted memory.

8. A mask-ROM holding device, comprising:
a first slot for holding a first mask-ROM, wherein said first slot is empty before a first period, and said first mask-ROM is inserted into said first slot during said first period;
a second slot for holding a second mask-ROM, said second slot being electrically coupled to said first slot, wherein said second slot is empty before a second period following said first period, and said second mask-ROM is inserted into said second slot during said second period.

9. The device according to claim 8, wherein said first or second mask-ROM is located in a memory card.

10. The device according to claim 8, wherein said mask-ROM is a three-dimensional mask-ROM (3D-MPROM).

11. The device according to claim 8, wherein said mask-ROM is an imprinted memory.

12. The device according to claim 8, wherein said device is coupled to a processing apparatus.

13. The device according to claim 12, wherein said processing apparatus comprises a communication means and a re-writable memory.

14. A hybrid content-distribution method, comprising the steps of:
1) incrementally transferring first contents to a re-writable memory (RWM) of a processing apparatus with a communicating means of said processing apparatus during a first period;
2) inserting a first mask-ROM storing said first contents into a first slot of a mask-ROM holding device at the end of said first period;
3) deleting said first contents from said RWM at the end of said first period;
4) incrementally transferring second contents to said RWM with said communicating means during a second period following said first period;
5) inserting a second mask-ROM storing said second contents into a second slot of said mask-ROM holding device at the end of said second period;
6) deleting said second contents from said RWM at the end of said second period;
wherein said first and second slots of said mask-ROM holding device are electrically coupled; and, said processing apparatus further comprises a coupling means to said mask-ROM holding device.

15. The hybrid content-distribution method according to claim 14, wherein said processing apparatus is a cellular phone, an internet TV, or a computer.

16. The hybrid content-distribution method according to claim 14, wherein said communicating means include internet, wireless LAN and cellular communication means.

17. The hybrid content-distribution method according to claim 14, wherein said RWM is a flash memory.

18. The hybrid content-distribution method according to claim 14, wherein said first or second mask-ROM is located in a memory card.

19. The hybrid content-distribution method according to claim 14, wherein said mask-ROM is a three-dimensional mask-ROM (3D-MPROM).

20. The hybrid content-distribution method according to claim 14, wherein said mask-ROM is an imprinted memory.
